(19) United States
(12) Patent Application Publication
(10) Pub. No.: US 2004/0032532 A1
(43) Pub. Date: Feb. 19, 2004

(54) Noise level detecting circuit

(76) Inventors: Hiroshi Akiyama, Kanagawa (JP); Shoji Nakashima, Kanagawa (JP); Ikuo Hirama, Kanagawa (JP)

Correspondence Address: Darryl G. Walker, WALKER & SAKO, LLP, Suite 235, 300 South First Street, San Jose, CA, 95113, US

(21) Appl. No.: 10/636,047

(22) Filed: Aug. 7, 2003

(30) Foreign Application Priority Data
Aug. 16, 2002 (JP) 2002-237623

(51) Int. Cl. H04N 5/21

(52) U.S. Cl. 348/607

(57) ABSTRACT

A noise level detecting circuit that can stably detect a noise with respect to a video signal or the like on which a copy guard signal is superimposed is disclosed. A noise level detecting circuit (100) of one embodiment can include an A/D converter (1) that converts an analog video signal (S1) into a digital video signal (S4). A timing generating circuit (3) may generate a bust gate pulse (S3) that determines a period during which the burst signal of the analog video signal (S1) is extracted. An absolute value circuit (5) may convert an extracted burst signal (S6) into only a positive pole component on the basis of a pedestal level signal (S5). A delay circuit (6) may delay the burst signal (S7) of only the positive pole component by 1H unit. A comparator (7) may compare the burst signal (S7) of only the positive pole component with the delayed burst signal (S8). In this way, the noise may be stably detected.

### TECHNICAL FIELD

The present invention relates generally to a noise level detecting circuit, and more particularly to a noise level detecting circuit that detects a noise component of a video signal.

### BACKGROUND OF THE INVENTION

A video device such as a television set or a video player generally has a noise level detecting circuit in order to obtain information related to a noise level. This information is necessary for controlling a noise suppressing circuit that suppresses the noise of a video signal.

For example, Japanese Patent Application laid-open 4-81076 A (JP 4-81076 A) discloses a technique in which a mean value of high frequency components contained in a video luminance signal is detected in a vertical synchronous signal period contained within a vertical fly-back erasing period (hereinafter referred to as a “vertical blanking period”). The noise level contained in the video luminance signal is detected in accordance with the amplitude of the voltage value obtained when the detected voltage is held over the effective video signal period. A noise suppressing circuit can be controlled according to the detected noise.

In recent years, there has been a wide spread use of video reproducing devices having a recording function. Examples of such video reproducing devices include digital video disc (DVD) recorders and video tape recorders (VTRs). In order to inhibit such devices from unauthorized duplicate recording, a copy guard signal is, in many cases, superimposed on a video signal. This copy guard signal can be detected by the DVD or VTR software/hardware to inhibit the video reproducing device from conducting a normal duplicate recording of the video. This can prevent illegal copying that can violate copyright law.

A general video reproducing device is equipped with an automatic gain control (AGC) circuit that compensates the level fluctuation of the video signal. However, some of the copy guard signals induce erroneous operation of the AGC circuit by superimposing a plurality of pulses that reach 100% white level in a short period within the vertical blanking period as illustrated in FIG. 4 (found on the Internet: NTSC video signal timing standard summary; http://elm-chan.org/docs/rs170a/spec_j.html). The AGC may overcompensate for such high signal levels. In this way, the video signal is made erroneously dark by the copying process. For this reason, in prior art approaches that detect the noise level on the basis of the signal in the vertical blanking period, there is a high possibility that the copy guard signal will be erroneously detected as a noise component.

Japanese Patent Application 2000-175077 A (JP 2000-175077 A) discloses a technique in which an AC component of a video luminance signal at a back porch portion in the horizontal blanking period is detected. At such a back porch portion, the standard of the signal waveform is strictly determined, such as shown for example in FIG. 5. The noise level is detected in accordance with the integration result of the AC components in the given period. Such an approach is applicable to the various video signal timing standards including NTSC, PAL, and SECAM for example, as noise is detected without using the above-mentioned vertical blanking period, where the copy guard signals are superimposed.

However, the approach in JP 2000-175077 A is not practical because the color burst signal, which serves as a color synchronizing signal, has been removed from the analog luminance signal. The analog luminance signal is input to the noise level detecting circuit to implement the conversion of the analog luminance signal into the digital luminance signal and implement an AC component extracting process.

To address the above-mentioned circumstances, a conventional noise level detecting circuit has been proposed that detects the noise level by using the back porch portion including the color burst signal of the blanking period. Such a conventional noise level detecting circuit is illustrated in a block schematic diagram in FIG. 6.

Referring now to FIG. 6, a conventional noise level detecting circuit includes an analog-to-digital (A/D) converter 101, a timing generating circuit 102, an AND circuit 103, an fsc (color sub-carrier frequency) trap circuit 104, a delay circuit 105, a comparator 106, and a switch 111. A/D converter 101 converts an analog video signal S101 into a digital video signal S104. Timing generating circuit 102 produces a burst gate pulse S103 from a horizontal synchronous signal S102. AND circuit 103 receives the digital video signal S104 and burst gate pulse S103 and provides an extracted burst signal S105. The fsc trap circuit 104 greatly attenuates frequency components close to 3.58 MHz contained in the extracted burst signal S105. Any one of the outputs from fsc trap circuit 104 and AND circuit 103 is input to delay circuit 105 and comparator 106 in accordance with the position of switch 111. Delay circuit 105 delays the extracted burst signal S105 by one horizontal scanning (1H) unit and outputs a burst signal S106. Comparator 106 compares the extracted burst signal S105 with the burst signal S106 delayed by the 1H unit and outputs a noise level detection signal S107 to a noise level detection signal output terminal 110.

The A/D converter 101, timing generating circuit 102, AND circuit 103, fsc trap circuit 104, switch 111, delay circuit 105, comparator 106, and noise level detection signal output terminal 110 are mutually connected as described above to constitute a noise level detecting circuit as a whole.

In the conventional noise level detecting circuit of FIG. 6, the analog signal S101 is input to A/D converter 101 and converted into the digital video signal S104. The horizontal synchronous signal S102 in the horizontal blanking period of the analog video signal S101 is input to timing generating circuit 102. The burst gate pulse S103, that determines a timing at which the burst signal in a given period is extracted, is prepared from the horizontal synchronous signal S102. The digital video signal S104 and burst gate pulse S103 are input to AND circuit 103. The burst signal S105 is extracted from the digital video signal S104 in only the period where the burst gate pulse S103 is generated. In the noise detection in accordance with the extracted burst signal S105, a case exists in which the above-mentioned copy guard signal or the like can be erroneously detected as the noise component. For that reason, in order to reduce the above error detection, a switch 111 has been provided. Switch 111 can be connected to the fsc trap circuit 104 that greatly attenuates the frequency components near 3.58 MHz. Thus, the extracted burst signal S105 and the delayed extracted bust signal S106 which is delayed by delay circuit 105 by 1H unit are input to comparator 106 and compared with each other. In this way, the noise level for each of the lines is detected. The noise level detection signal S107 is provided from comparator 106 to noise level detection signal output terminal 110.

However, in the above-mentioned conventional noise level detecting circuit, part of the burst signal is extracted as it is and the extracted signal is used for noise detection. For that reason, for example, when the noise detection is going to be implemented on the input signal including a copy guard signal where the phase of the burst signal is different in each of the horizontal fly-back lines, the possibility that the burst signal is erroneously detected as the noise signal is high.

In light of the above, it would be desirable to provide a noise level detecting circuit that may detect a noise with respect to a video signal on which a copy guard signal is superimposed. In particular, it would be desirable to stably detect such a noise and detect such noise with high reliability.

### SUMMARY OF THE INVENTION

According to the embodiments, a noise level detecting circuit may stably detect a noise with respect to a video signal or the like on which a copy guard signal is superimposed. A noise level detecting circuit may include an A/D converter that converts an analog video signal into a digital video signal. A timing generating circuit may generate a burst gate pulse that determines a period during which the burst signal of the analog video signal is extracted. An absolute value circuit may convert an extracted burst signal into only a positive pole component on the basis of a pedestal level signal. A delay circuit may delay the burst signal of only the positive pole component by 1H unit. A comparator may compare the burst signal of only the positive pole component with the delayed burst signal. In this way, the noise may be stably detected.

According to one aspect of the embodiments, a noise level detecting circuit may include a pedestal level detecting circuit and an absolute value circuit. A pedestal level detecting circuit may receive a digital video signal and provide a pedestal level signal. An absolute value circuit may receive a pedestal level signal and provide a positive pole component burst signal.

According to another aspect of the embodiments, a noise level detecting circuit may include an analog to digital (A/D) converter. An A/D converter may receive an analog video signal and provide a digital video signal.

According to another aspect of the embodiments, a noise level detecting circuit may include a timing generating circuit and an AND circuit. A timing generating circuit may receive a horizontal synchronous signal and provide a burst gate pulse. An AND circuit may receive a digital video signal and a burst gate pulse and output an extracted burst signal.

According to another aspect of the embodiments, a noise level detecting circuit may include a delay circuit. A delay circuit may receive the positive pole component burst signal and provide a delayed signal.

According to one aspect of the embodiments, a noise level detecting circuit may include a comparator. A comparator may receive a positive pole component burst signal and a delayed signal and provide a noise level detecting signal.

According to another aspect of the embodiments, the delay circuit may delay the positive pole component burst signal by one horizontal scanning unit to provide the delayed signal.

According to another aspect of the embodiments, a noise level detecting circuit may include a line integrating circuit. A line integrating circuit may receive a noise level detecting signal and provide a line integrated noise level detection signal.

According to another aspect of the embodiments, a noise level detecting circuit may include a field integrating circuit. A field integrating circuit may receive a line integrated noise level detection signal and provide a field integrated noise level detection signal.

According to another aspect of the embodiments, a noise level detecting circuit may include a pedestal level detecting circuit and an absolute value circuit. A pedestal level detecting circuit may receive a digital video signal and provide a pedestal level signal. An absolute value circuit may receive a pedestal level signal and provide a positive pole component burst signal. The pedestal level detecting circuit may detect a pedestal level of the digital video signal and the absolute value circuit may convert the extracted burst signal into the positive pole component burst signal.

According to one aspect of the embodiments, a noise level detecting circuit may include an analog to digital (A/D) converter. An A/D converter may receive an analog video signal and provide a digital video signal. The A/D converter may convert the analog video signal into the digital video signal.

According to another aspect of the embodiments, a noise level detecting circuit may include a timing generating circuit and an AND circuit. A timing generating circuit may receive a horizontal synchronous signal and provide a burst gate pulse. An AND circuit may receive a digital video signal and a burst gate pulse and output an extracted burst signal. The timing generating circuit may generate the burst gate pulse for extracting a burst signal during a period where the burst signal exists in a horizontal blanking period and the AND circuit may extract the burst signal from the digital video signal when the burst gate pulse is provided.

According to another aspect of the embodiments, a noise level detecting circuit may include a delay circuit. A delay circuit may receive the positive pole component burst signal and provide a delayed signal. The delay circuit may delay the positive pole component burst signal by one horizontal scanning unit to provide the delayed signal.

According to another aspect of the embodiments, a noise level detecting circuit may include a comparator. A comparator may receive a positive pole component burst signal and a delayed signal and provide a noise level detecting signal. The comparator may compare the positive pole component burst signal with the delayed signal to provide the noise level detecting signal.

According to another aspect of the embodiments, a noise level detecting circuit may include a line integrating circuit. A line integrating circuit may receive a noise level detecting signal and provide a line integrated noise level detection signal. The line integrating circuit may integrate signal comparison information from the comparator by a given scanning line period.

According to another aspect of the embodiments, a noise level detecting circuit may include a field integrating circuit. A field integrating circuit may receive a line integrated noise level detection signal and provide a field integrated noise level detection signal. The field integrating circuit may integrate the signal comparison information after the line integration by a given field period.

According to the embodiments, a noise level detecting circuit may include an analog to digital converter that converts an analog video signal into a digital video signal, a pedestal level detecting circuit that detects a pedestal level of the digital signal, a timing generating circuit that generates a burst gate pulse for extracting a burst signal during a period where the burst signal exists in a horizontal blanking period, an AND circuit that extracts the burst signal from the digital video signal in a period of the burst gate pulse, an absolute value circuit that converts the burst signal into a positive component burst signal with respect to the pedestal level, a delay circuit that delays the positive component burst signal, and a comparator that compares one positive component burst signal with another positive component burst signal delayed by the delay circuit.

According to another aspect of the embodiments, a noise level detecting circuit may include an analog to digital converter that converts an analog video signal into a digital video signal, a pedestal level detecting circuit that detects a pedestal level of the digital signal, a timing generating circuit that generates a burst gate pulse for extracting a burst signal during a period where the burst signal exists in a horizontal blanking period, an AND circuit that extracts the burst signal from the digital video signal in a period of the burst gate pulse, an absolute value circuit that delays the burst signal by one horizontal scanning unit, a comparator that compares the burst signal with a burst signal delayed by the delay circuit, a line integrating circuit that integrates signal comparison information from the comparator by a predetermined scanning line period, and a field integrating circuit that integrates information after the line integration by a predetermined field period.

### BRIEF DESCRIPTION OF THE DRAWINGS

FIG. 1 is a block schematic diagram of a noise level detecting circuit according to an embodiment.

FIG. 2 is timing diagram illustrating the operation of the noise level detecting circuit of FIG. 1.

FIG. 3 is a block schematic diagram of a noise level detecting circuit according to an embodiment.

FIG. 4 is a diagram for explaining a copy guard signal superimposed in a vertical blanking period.

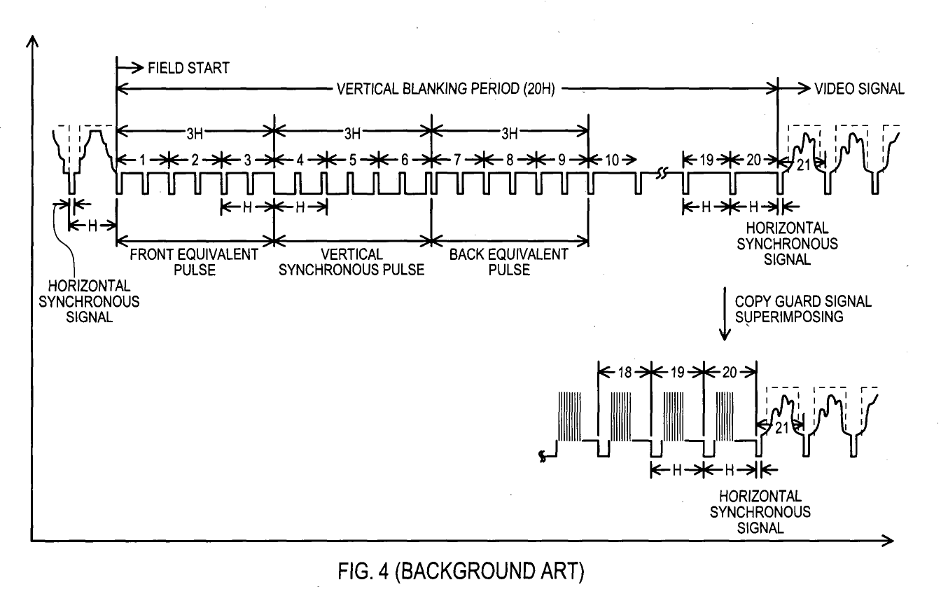

FIG. 5 is a diagram for explaining a synchronous signal in a horizontal blanking period.

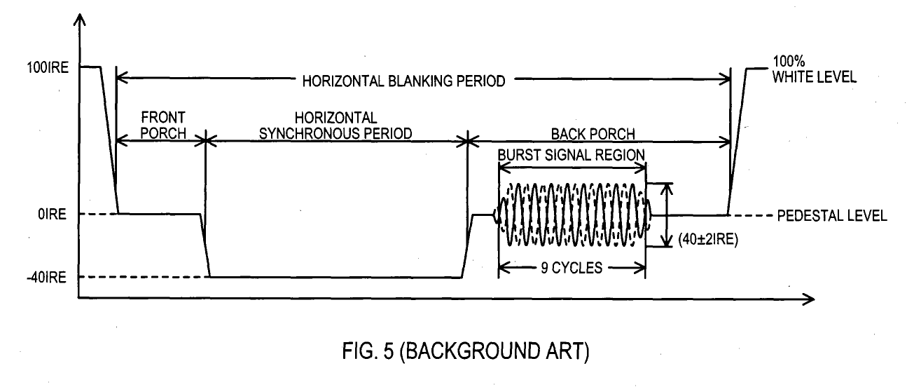

FIG. 6 is a block schematic diagram of a conventional noise level detecting circuit.

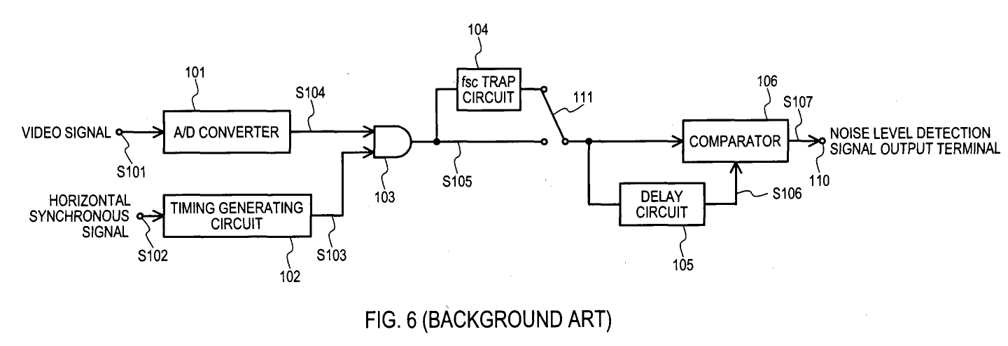

### DETAILED DESCRIPTION OF THE EMBODIMENTS

Various embodiments of the present invention will now be described in detail with reference to a number of drawings.

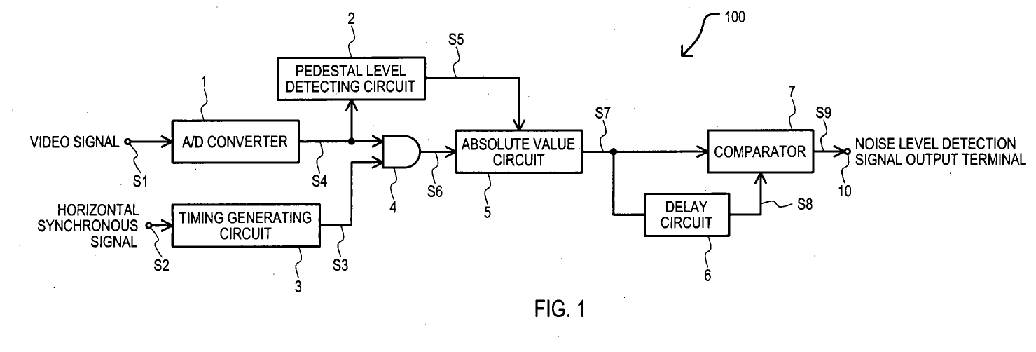

Referring now to FIG. 1, a block schematic diagram of a noise level detecting circuit according to an embodiment is set forth and given the general reference character 100.

Noise level detecting circuit 100 may include an A/D converter 1, a pedestal level detecting circuit 2, a timing generating circuit 3, an AND circuit 4, an absolute value circuit 5, a delay circuit 6, and a comparator 7. A/D converter 1 may convert a received analog video signal S1 into a digital video signal S4. A/D converter 1 may provide a digital video signal S4 to pedestal level detecting circuit 2 and AND circuit 4. Pedestal level detecting circuit 2 may detect a pedestal level of a digital video signal S4 and provide a pedestal level signal S5 to an absolute value circuit 5. Pedestal level signal S5 may be a zero level of a digital video signal S4. Timing generating circuit 3 may receive a horizontal synchronous signal S2 and generate a burst gate pulse S3 for extracting a burst signal in a given period where the burst signal exists in the horizontal blanking period of an analog video signal S1. A burst gate pulse S3 may be received at an input of AND circuit 4. AND circuit 4 may extract a part of the burst signals from a back porch in a horizontal blanking period of a digital video signal S4 in a given period determined in accordance with a burst gate pulse S3. AND circuit 4 may output an extracted burst signal S6 as an input to absolute value circuit 5. Absolute value circuit 5 may convert an extracted burst signal S6 into only a positive pole component on the basis of a pedestal level signal S5 that is detected by pedestal level detecting circuit 2. Absolute value circuit 5 may output a burst signal S7 that has been converted into only a positive pole component.

Absolute value circuit 5 may output a burst signal S7 that has been converted into only a positive pole component to delay circuit 6 and comparator circuit 7. Delay circuit 6 may delay a burst signal S7 that has been converted into only a positive pole component by a 1H unit and output a burst signal S8. Then, comparator 7 may compare a burst signal S7 which has been converted into a positive pole component with a burst signal S8 that has been delayed by delay circuit 6 to output a noise level detection signal S9 to a noise level detection signal output terminal 10.

As described above, an A/D converter 1, a pedestal level detecting circuit 2 a timing generating circuit 3 and AND circuit 4, an absolute value circuit 5, a delay circuit 6, a comparator 7, and a noise level detection signal output terminal 10 may be mutually connected to constitute a noise level detecting circuit 100 as a whole.

The operation of noise level detecting circuit 100 will now be described.

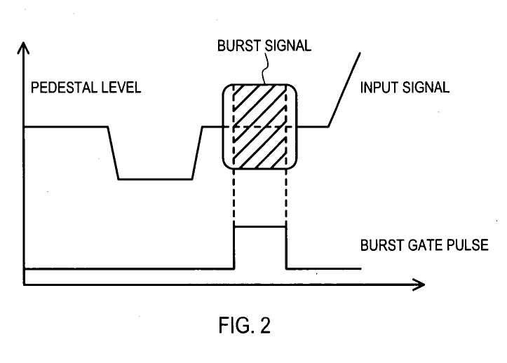

First, a received analog video signal S1 may be converted into a digital video signal S4 by A/D converter 1. A digitalized video signal S4 may be provided to pedestal level detecting circuit 2 by which a pedestal level signal S5 that is a zero level of a video signal S4 is detected. On the other hand, a horizontal synchronous signal S2 of an analog video signal S1 may be provided to timing generating circuit 3. Timing generating circuit 3 may produce a burst gate pulse S3 for determining a period during which the burst signal that exists at a back porch in a horizontal blanking period is extracted in accordance with a horizontal synchronous signal S2. In this case, a rising timing and pulse width of the burst gate pulse S3 can be set to desired values. The burst gate pulse S3 and the digital video signal S4 may be input to AND circuit 4. AND circuit 4 may extract a part of the burst signals from the horizontal blanking period of the digital video signal S4 in only a period where the burst gate pulse S3 is generated as illustrated in the timing diagram of FIG. 2.

A burst signal S6 thus extracted may be input to absolute value circuit 5 together with the pedestal level signal S5 that is a zero level of the digital video signal S4 that is detected by pedestal level detecting circuit 2. The extracted burst signal S6 may have a negative pole component folded back on the basis of the pedestal level signal S5 and may be converted into only a positive pole component by absolute value circuit 5. In this case, the pedestal level signals S5 may be detected by pedestal level detecting circuit 2 every time the burst signals are extracted at the timing where the burst gate pulse S3 is generated. The burst signal S7 that has been converted into only a positive pole component may be input to delay circuit 6. Delay circuit 6 may convert the burst signal S7 into a delayed burst signal S8 that has been delayed by the 1H unit. The delayed burst signal S8 may be input to comparator 7 together with the present burst signal S7 that has been converted into the positive pole component. Comparator 7 may take a difference between the present burst signal S7 and the delayed burst signal S8 for comparison. In this way, a noise level detection signal S9 may be detected.

A delay time provided by delay circuit 6 for delaying burst signal S7 is not particularly limited and may be set to an arbitrary time by the 1H unit by taking into consideration a preferred position of a line for comparison of the video signals and a circuit scale of the noise suppressing circuit or the like including noise level detecting circuit 100.

Noise level detecting circuit 100 may detect the noise level in a burst signal region that exists at the back porch in the horizontal blanking period of the video signal. Because a color signal is superimposed on a luminance signal, in a composite color video signal such as the video signal, the burst signal may be essential as a reference signal for determining the phase. For that reason, except for a case in which the copy guard signal is superimposed on the burst signal region, a noise detection effect may be securely obtained by extracting the given period of the burst signal region and using the given period for detection of the noise level. In comparison, the conventional approach of the prior art detects the noise level in the vertical blanking period where the copy guard signal is frequently superimposed.

Also, a case exists in which the phase of the burst signal that is not only in the vertical blanking period but also in the horizontal blanking period is different in each of the lines, depending on the kind of the copy guard signal. In this case, when a comparison is made without converting the burst signal into only the positive pole component, the burst signal per se can be erroneously detected as noise. Therefore, noise level detecting circuit 100 converts the burst signal that is in the horizontal blanking period of the video signal into only the positive pole component and uses the burst signal for detection of the noise level. As a result, even in the case where the video signal on which the copy guard signal having the phase of the burst signal different in each of the lines has been superimposed is input, a noise detection that is high in reliability may be stably performed.

Also, in the conventional noise level detecting circuit, the fsc trap circuit may be added as described above as a countermeasure against the noise detection error that occurs in the case where a signal on which the copy guard signal is superimposed is input. However, in a noise level detecting circuit 100 according to the present embodiment, the fsc trap circuit is not required and the noise level detection using a total frequency band that is high in reliability can be performed with a more simple circuit structure.

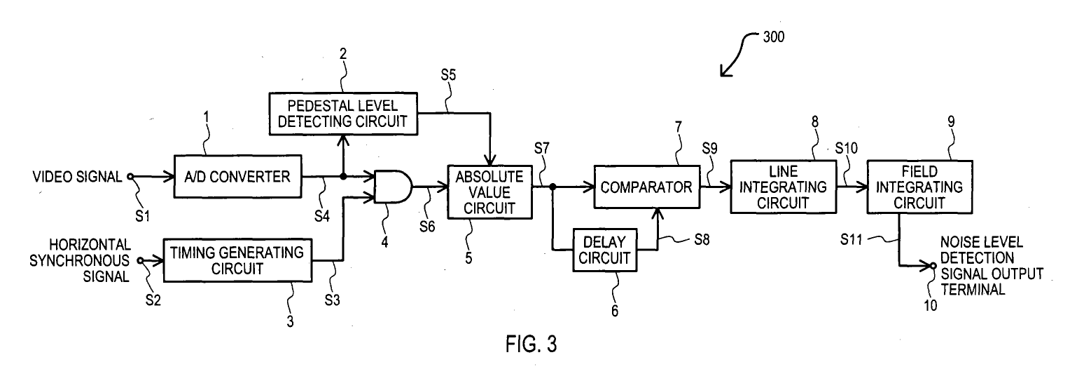

Referring now to FIG. 3, a block schematic diagram of a noise level detecting circuit according to an embodiment is set forth and given the general reference character 300.

Noise level detecting circuit 300 may include an A/D converter 1, a pedestal level detecting circuit 2, a timing generating circuit 3, an AND circuit 4, an absolute value circuit 5, a delay circuit 6, and a comparator 7 as in noise level detecting circuit 100 in the embodiment of FIG. 1. However, noise level detecting circuit 300 may differ from noise level detecting circuit 100 in that noise level detecting circuit 300 may also include a line integrating circuit 8 and a field integrating circuit 9.

A/D converter 1 may convert a received analog video signal S1 into a digital video signal S4. A/D converter 1 may provide a digital video signal S4 to pedestal level detecting circuit 2 and AND circuit 4. Pedestal level detecting circuit 2 may detect a pedestal level of a digital video signal S4 and provide a pedestal level signal S5 to an absolute value circuit 5. Pedestal level signal S5 may be a zero level of a digital video signal S4. Timing generating circuit 3 may receive a horizontal synchronous signal S2 and generate a burst gate pulse S3 for extracting a burst signal in a given period where the burst signal exists in the horizontal blanking period of an analog video signal S1. A burst gate pulse S3 may be received at an input of AND circuit 4. AND circuit 4 may extract a part of the burst signals from a back porch in a horizontal blanking period of a digital video signal S4 in a given period determined in accordance with a burst gate pulse S3. AND circuit 4 may output an extracted burst signal S6 as an input to absolute value circuit 5. Absolute value circuit 5 may convert an extracted burst signal S6 into only a positive pole component on the basis of a pedestal level signal S5 that is detected by pedestal level detecting circuit 2. Absolute value circuit 5 may output a burst signal S7 that has been converted into only a positive pole component.

Absolute value circuit 5 may output a burst signal S7 that has been converted into only a positive pole component to delay circuit 6 and comparator circuit 7. Delay circuit 6 may delay a burst signal S7 that has been converted into only a positive pole component by a 1H unit and output a burst signal S8. Then, comparator 7 may compare a burst signal S7 that has been converted into a positive pole component with a burst signal S8 that has been delayed by delay circuit 6 to output a noise level detection signal S9 to line integrating circuit 8.

Line integrating circuit 8 may integrate the noise level detection signal S9 over a given line period and output a line integrated noise level detection signal S10 to a field integrating circuit 9. Field integrating circuit 9 may integrate the line integrated noise level detection signal S10 over a given field period and may output the integrated signal to a noise level detection signal output terminal 10.

As described above, an A/D converter 1, a pedestal level detecting circuit 2 a timing generating circuit 3 and AND circuit 4, an absolute value circuit 5, a delay circuit 6, a comparator 7, a line integrating circuit 8, a field integrating circuit 9, and a noise level detection signal output terminal 10 may be mutually connected to constitute a noise level detecting circuit 300 as a whole. Noise level detecting circuit 300 according to the embodiment of FIG. 3 may also be formed by adding a line integrating circuit 8 and field integrating circuit 9 to a post stage of noise level detecting circuit 100 according to the embodiment of FIG. 1.

In the embodiments, noise level detection signal S11 that is detected by comparing burst signals that have been converted into only the positive components between arbitrary lines and taking a difference between the burst signals may be further integrated over an arbitrary line period and an arbitrary field period. For that reason, even in the case where a signal that fluctuates due to a sudden disturbance factor and an unexpected temporal fluctuation factor is input, a noise level detection that is averaged, stably performed, and high in reliability may be realized. Thus, it may be considered that a noise level detecting circuit according to the embodiments is more practical and higher in reliability. More particularly, a noise level detecting circuit according to the embodiment of FIG. 3 may be even more practical and even higher in reliability.

As was described above in detail, according to the embodiments, a video signal of an analog signal or the like may be digitized. The burst signals in the horizontal blanking period contained in the digitized video signal may be extracted over a given period. Signals that have been converted into only the positive pole components may be used for detection of the noise level. In this way, a noise level with respect to a video signal on which a copy guard signal is superimposed may be detected with stability and high reliability.

While various particular embodiments set forth herein have been described in detail, the present invention could be subject to various changes, substitutions, and alterations without departing from the spirit and scope of the invention. Accordingly, the present invention is intended to be limited only as defined by the appended claims.

What is claimed is:

1. A noise level detecting circuit, comprising:
a pedestal level detecting circuit coupled to receive a digital video signal and providing a pedestal level signal; and
an absolute value circuit coupled to receive the pedestal level signal and providing a positive pole component burst signal.

2. The noise level detecting circuit of claim 1, further including:
an analog to digital converter coupled to receive an analog video signal and providing the digital video signal.

3. The noise level detecting circuit of claim 1, further including:
a timing generating circuit coupled to receive a horizontal synchronous signal and providing a burst gate pulse; and
an AND circuit coupled to receive the digital video signal and the burst gate pulse and providing an extracted burst signal.

4. The noise level detecting circuit of claim 1, further including:
a delay circuit coupled to receive the positive pole component burst signal and provide a delayed signal.

5. The noise level detecting circuit of claim 4, further including:
a comparator coupled to receive the positive pole component burst signal and the delayed signal and providing a noise level detecting signal.

6. The noise level detecting circuit of claim 5, wherein:
the delayed circuit delays the positive pole component burst signal by one horizontal scanning unit to provide the delayed signal.

7. The noise level detecting circuit of claim 5, further including:
a line integrating circuit coupled to receive the noise level detecting signal and providing a line integrated noise level detection signal.

8. The noise level detecting circuit of claim 7, further including:
a field integrating circuit coupled to receive the line integrated noise level detection signal and providing a field integrated noise level detection signal.

9. A noise level detecting circuit, comprising:
a pedestal level detecting circuit coupled to receive a digital video signal and providing a pedestal level signal; and
an absolute value circuit coupled to receive the pedestal level signal and an extracted burst signal and providing a positive pole component burst signal;
wherein the pedestal level detecting circuit detects a pedestal level of the digital video signal and the absolute value circuit converts the extracted burst signal into the positive pole component burst signal.

10. The noise level detecting circuit of claim 9, further including:
an analog to digital converter coupled to receive an analog video signal and providing the digital video signal wherein the analog to digital converter converts the analog video signal into the digital video signal.

11. The noise level detecting circuit of claim 10, further including:
a timing generating circuit coupled to receive a horizontal synchronous signal and providing a burst gate pulse; and
an AND circuit coupled to receive the digital video signal and the burst gate pulse and providing the extracted burst signal;
wherein the timing generating circuit generates the burst gate pulse for extracting a burst signal during a period where the burst signal exists in a horizontal blanking period and the AND circuit extracts the burst signal from the digital video signal when the burst gate pulse is provided.

12. The noise level detecting circuit of claim 9, further including:
a delay circuit coupled to receive the positive pole component burst signal and provide a delayed signal.

13. The noise level detecting circuit of claim 12, wherein:
the delay circuit delays the positive pole component burst signal by one horizontal scanning unit to provide the delayed signal.

14. The noise level detecting circuit claim 12, further including:
a comparator coupled to receive the positive pole component burst signal and the delayed signal and providing a noise level detecting signal
wherein the comparator compares the positive pole component burst signal with the delayed signal to provide a noise level detecting signal.

15. The noise level detecting circuit of claim 14, further including:
a line integrating circuit coupled to receive the noise level detecting signal and providing a line integrated noise level detection signal.

16. The noise level detecting circuit of claim 15, wherein:
the line integrating circuit integrates signal comparison information from the comparator by a given scanning line period.

17. The noise level detecting circuit of claim 15, further including:
a field integrating circuit coupled to receive the line integrated noise level detection signal and providing a field integrated noise level detection signal.

18. The noise level detecting circuit of claim 17, wherein:
the line integrating circuit integrates signal comparison information from the comparator by a given scanning line period and the field integrating circuit integrates the signal comparison information after the line integration by a given field period.

19. A noise level detecting circuit, comprising:
an analog to digital converter that converts an analog video signal into a digital video signal;
a pedestal level detecting circuit that detects a pedestal level of the digital video signal;
a timing generating circuit that generates a burst gate pulse for extracting a burst signal during a period where the burst signal exists in a horizontal blanking period;
an AND circuit that extracts the burst signal from the digital video signal in a period of the burst gate pulse;
an absolute value circuit that converts the burst signal to a positive component burst signal with respect to the pedestal level;
a delay circuit that delays the positive component burst signal; and
a comparator that compares one positive component burst signal with another positive component burst signal delayed by the delay circuit.

20. The noise level detecting circuit of claim 19, further including:
a line integrating circuit that integrates signal comparison information from the comparator by a predetermined scanning line period; and
a field integrating circuit that integrates information after the line integration by a predetermined field period.
